(19) United States
(12) Patent Application Publication
(10) Pub. No.: US 2011/0253258 A1
(43) Pub. Date: Oct. 20, 2011

(54) CONTAINER-HANDLING MACHINE

(75) Inventors: Bernd Neumann, Hamburg (DE); Andre Neuhauser, Sorgenloch (DE)

(73) Assignee: KHS GmbH, Dortmund (DE)

(21) Appl. No.: 13/141,722

(22) PCT Filed: Dec. 16, 2009
(86) PCT No.: PCT/EP2009/009003

§ 371 Date: Jun. 23, 2011

(30) Foreign Application Priority Data
Jan. 19, 2009 (DE) 10 2009 005 434.0

(51) Int. Cl. B67C 3/34

(52) U.S. Cl. 141/283

(57) ABSTRACT

The invention relates to a recirculating construction machine for handling bottles or similar containers, having a rotor rotatably supported about a vertical machine axis on a machine frame and that can be driven about said machine axis, having a plurality of handling positions on the rotor, having an annular enclosure concentrically enclosing the machine axis and forming, or the housing thereof forming, an interior bounded from the environment and tillable with a sterile gaseous and/or vapor medium, in which the functional elements of the handling positions each extend at least into a partial area acting together with the containers, and in which the containers are received at least in an opening area during handling.

The invention relates to a container processing machine according to the preamble of Claim 1.

Different designs of container processing machines are known, especially also of those of the rotating type which in each case have processing positions at a rotor that is driven in a rotating manner about a vertical machine axis. For sterile or germ-free processing of containers, for example for sterile or germ-free filling and/or closing of containers, there are also container processing machines known, i.e. filling machines or closing machines of the rotating type, where the processing positions are provided in a ring-shaped enclosure that surrounds the machine axis in a concentric manner or in a sterile or clean chamber that is formed by the enclosure. The sterile or clean chamber is traversed by a sterile gaseous and/or vaporous medium, for example sterile air, during the operation of the container processing machine. The design, in this case, is such that the respective container, accommodated at a processing position and held at the container carrier at that location, is arranged in the sterile or clean chamber at least by way of its container region that includes the container opening, such that the sterile processing of the containers, i.e. sterile filling or closing of the containers, is possible.

In the case of known container processing machines of this type, the housing of the enclosure in each case is formed in part by wall portions that rotate with the rotor and in part also, however, by wall portions that do not rotate with the rotor, such that between the rotating and the non-rotating wall portions gap-shaped transitions are forcibly produced. These transitions that are provided directly at the enclosure or directly at the sterile chamber have enormous disadvantages. Thus, for example, costly seals are necessary directly at the sterile chamber, as if no seals are provided the sterile gaseous and/or vaporous medium emerging from the transitions produce not only undesirable losses of said medium, but also unwanted turbulence and/or flows that impair the germ-free or sterile processing of the containers.

It is the object of the invention to provide a container processing machine that avoids these disadvantages. This object is achieved by a container processing machine corresponding to Claim 1.

One characteristic of the container processing machine is that the entire housing, i.e. all the wall portions of the housing of the enclosure that forms the sterile or clean chamber, are provided exclusively on the rotor, that is to say there are no transitions between rotating and non-rotating wall portions in the region of the sterile or clean chamber.

The supplying of the sterile gaseous and/or vaporous medium to the enclosure or to the sterile and clean chamber is effected via at least one ring transferring means, preferably not in a direct manner but by means of a ring-shaped distributor chamber that preferably communicates with the sterile or clean chamber.

Further developments, advantages and application possibilities of the invention are also produced from the following description of exemplary embodiments and from the Figures. In this case, all features described and/or graphically represented, individually or in arbitrary combination, are in principle the object of the invention, irrespective of their summary in the claims or their dependency. The content of the claims is also made a component of the description.

The invention is explained below by way of the Figures of exemplary embodiments, in which, in detail:

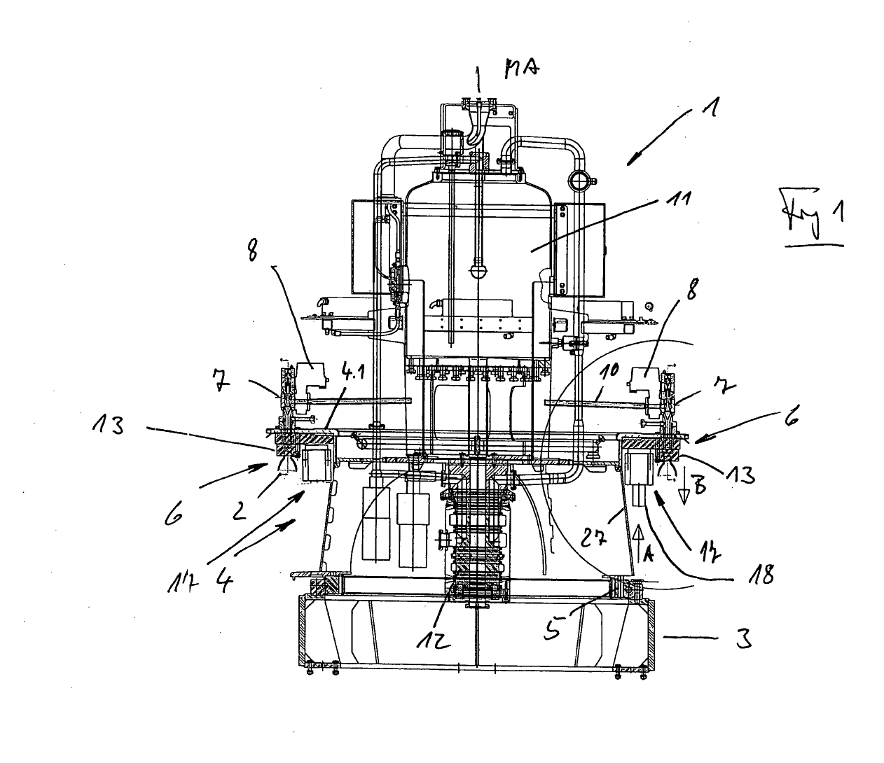

FIG. 1 shows a sectional representation of the processing machine for bottles in its embodiment as a filling machine;

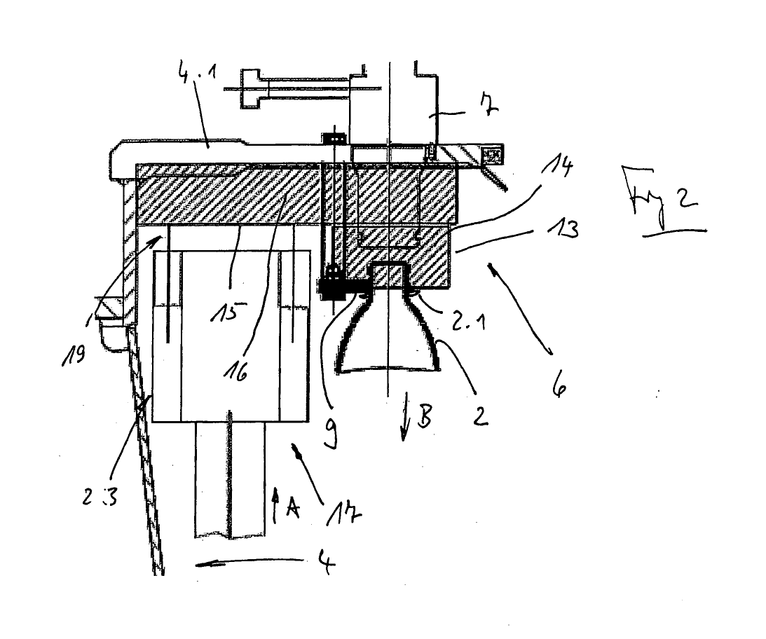

FIG. 2 shows a detail in FIG. 1;

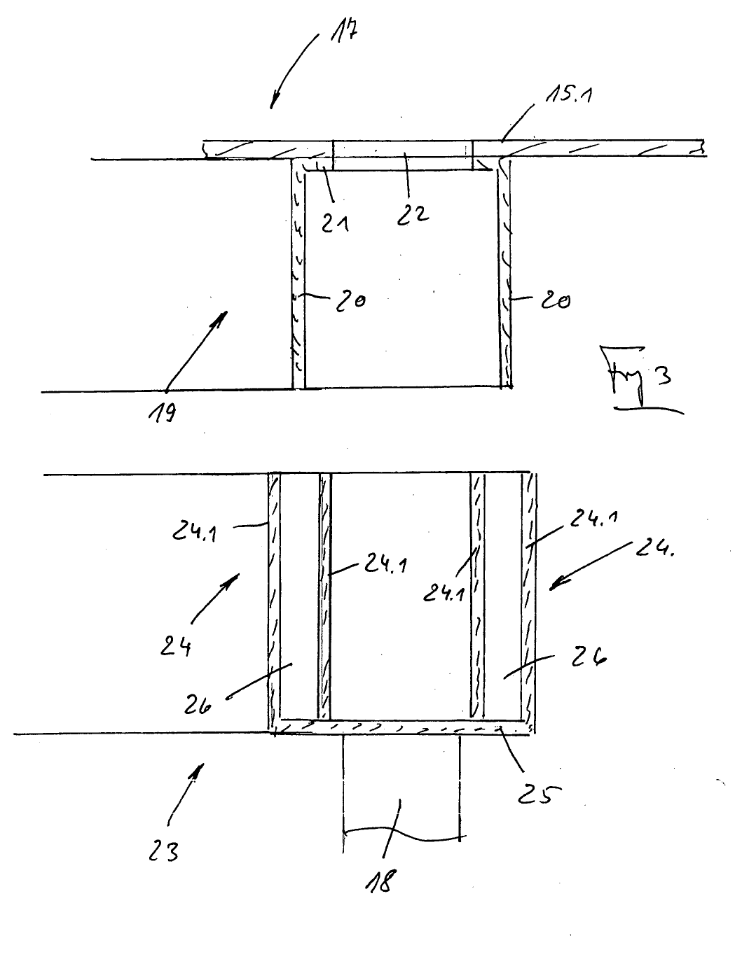

FIG. 3 shows a component drawing of the elements of a ring transferring means;

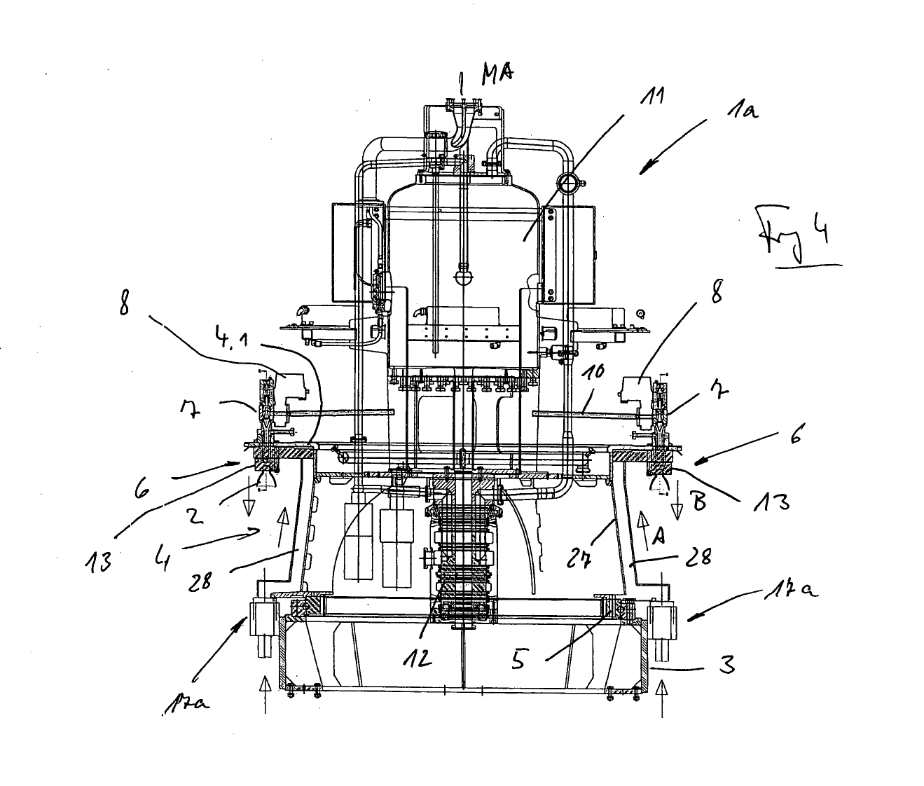

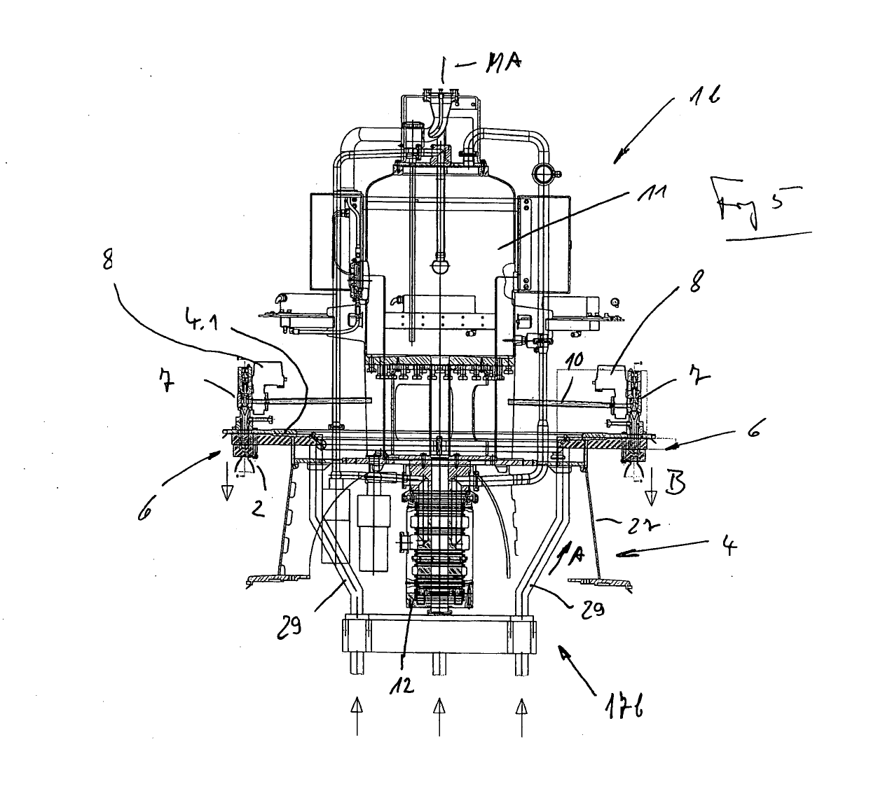

FIGS. 4 and 5 show representations as FIG. 1, with further embodiments of the invention.

In FIG. 1 the reference 1 is given to a filling machine of the rotating type for filling containers in the form of bottles 2 with a liquid product or product. In a known manner, the filling machine 1 comprises, among other things, a lower machine frame 3 and a rotor 4, which is mounted on the top side of the machine frame 3 with the aid of a bearing 5 that is formed by a ball rotary connection so as to be rotatable about a vertical machine axis MA and is driveable in a rotating manner about the machine axis MA by means of a drive (not shown).

A plurality of filling positions 6 are formed at the circumference of the rotor 4, said filling positions in each case comprising, among other things, a fill element 7 with flow meter 8 for the volume-controlled or fill-amount-controlled delivery of the liquid product into the bottles 2 and a bottle or container carrier 7, on which the bottle 2 to be filled in each case is held in a suspended manner at a ring or mouth flange 2.1 realized in the region of the bottle opening. In the case of the embodiment represented, the filling machine 1 is used for the open jet filling of the bottles 2 with the liquid product, i.e. each bottle 2, held in a suspended manner at the container carrier 9 by way of its bottle mouth, is at a spacing from the bottom end of the fill element 7 or from the discharge opening for the liquid product at that location (FIG. 2).

The fill element 7 and the associated container carrier 9 are provided on a ring-shaped portion 4.1 of the rotor 4 that is located radially on the outside, surrounds the machine axis MA in a concentric manner and protrudes beyond the remaining outer contour of the rotor 4, with the fill elements 7 and the flow meters 8 substantially above the portion 4.1 and the container carrier 7 below said portion.

The fill elements 7 are in each case connected via a product line 10, in which the flow meter 8 is also located, to a boiler 11 that is mounted on the rotor for accommodating the liquid product. The liquid product and other media necessary to the operation of the filling machine 1, for example CO2 gas or a vacuum, are supplied to the boiler 11 or to other functional elements provided on the rotor 4 by means of a multiple rotary connection given the general reference 12 in FIG. 1.

For the germ-free or sterile filling of the liquid product into the bottles 2, there is provided on the underside of the ring-shaped portion 4.1 a circular-ring-shaped enclosure 13 that is arranged on the identical axis as the machine axis, the interior space of said enclosure being defined towards the surrounding area by a housing or by wall portions that form said housing and forming a sterile processing chamber or a sterile or clean chamber. The fill elements 7 extend from above into the interior space 14 of the enclosure 13 by way of their bottom end that includes the discharge opening for the liquid product. In addition, the enclosure 13 is also realized such that the bottles 2 held in a suspended manner on the container carriers 9 extend into the interior space 14 from below by way of their mouth region that includes the bottle mouth and also the respective mouth flange 2.1 or are accommodated in the enclosure 13 by way of said mouth region.

At least during the operation of the filling machine, the interior space 14 of the enclosure 13 is traversed by a sterile gaseous and/or vaporous medium, for example by sterile air, such that the bottles 2 for the sterile filling are accommodated by way of their mouth region in the clean or sterile chamber formed by the interior space 14, protruding downwards out of said clean or sterile chamber with the rest of their bottle body. This makes it possible to keep volumes of the interior space 14 small and thereby, in particular, also to keep down the consumption of the sterile gaseous and/or vaporous medium that, however, has nevertheless to be supplied in a volume flow of a not inconsiderable size to the interior space 14 of the enclosure 13 to achieve the necessary sterility. In order to achieve this, on the underside of the ring-shaped portion 4.1 and offset inward in a radial manner with reference to the fill elements 7 and the container carrier 9, the enclosure 13 has a ring-shaped extension 15, the dimension of which in the embodiment represented being smaller in an axial direction parallel to the machine axis MA than the corresponding dimension of the enclosure 13 and its interior space also being closed towards the surrounding area by means of wall portions and communicating with the interior space 14 or forming a continuation of the interior space 14.

On its underside, the ring-shaped extension 15 that surrounds the machine axis MA likewise in a concentric manner, sealed off towards the surrounding area, is connected via a ring transferring means 17 to at least one line 18 that does not rotate with the rotor 4, by means of which line the sterile vaporous and/or gaseous medium is supplied (arrow A).

The enclosure 13 is realized with, among other things, openings for the targeted output of the sterile gaseous and/or vaporous medium, for example with at least one opening on the enclosure underside in the region of the container carrier 9, such that the sterile gaseous and/or vaporous medium for forming the necessary flow within the enclosure 13 can emerge at that location corresponding to the arrow B.

The ring transferring means 17, in the case of this embodiment, is located directly below the extension 15 and consequently directly below the ring-like portion 4.1 of the rotor and essentially comprises, as shown in FIGS. 2 and 3, a circular-ring-shaped channel-like ring transferring element 19 with a U-shaped ring cross section, which is formed by legs 20 and one wall portion 21 connecting said legs. The ring transferring element 19 is mounted on the underside of the extension 15 or on a wall portion 19.1 of the housing of the extension forming the underside in such a manner that the two circular-ring-shaped legs 20, by way of their surface sides arranged parallel to the vertical machine axis MA, surround said machine axis MA in a concentric manner and the yoke portion 21, by way of its surface sides, lies in a plane perpendicular to the machine axis MA. In addition, the ring transferring element 19 is mounted such that it points downward by way of the open side of its U-shaped profile. The interior space of the ring transferring element 19 formed between the legs 20, sealed off towards the outside, communicates with the interior space 16 of the extension 15 by means of a plurality of openings 22.

The ring transferring means 17 additionally comprises a circular-ring-shaped ring transferring element 23, which also has a substantially U-shaped ring cross section, produced from the two leg portions 24 and the yoke portion 25 that connects said leg portions.

The two leg portions 24 are in each case double-walled, in each case comprising two circular-ring-shaped wall portions 24.1, which are arranged concentrically one to the other and at a spacing from each other and form between them in each case an annular channel 26 that is closed on one side by the yoke portion 25. The ring transferring element 23 is secured to the machine frame 3 so as not to rotate with the rotor 4, in such a manner that the open side of its U-profile points upward and in each case a leg 20 of the ring transferring element 19 extends into an annular channel 26 of the ring transferring element 23 such that the ring-shaped interior space of the ring transferring element 23 formed between the double walled leg portions 20, into which ring-shaped interior space the at least one line 18 opens out, communicates with the interior space of the ring transferring element 19 formed between the portions 20 and consequently also with the interior space 16. The two ring transferring elements 19 and 23 consequently form a labyrinth seal with low losses of the sterile gaseous and/or vaporous medium transferred via the ring transferring means 17 in the region of said seal. The annular spaces 26, however, are preferably filled with a liquid sealing medium during the operation of the filling machine 1, for example with sterile water, such that the ring transferring elements 19 and 23 then form a surge-tank-like or siphon-like seal for sealing off the ring transferring means 17.

The ring transferring means 17 is arranged outside the rotor inner region, which is surrounded by a rotor housing 27 and is taken up not only by the multiple rotary connection 12 and the lines leading to said rotary connection, but also by other functional elements of the filling machine 1 or of the rotating rotor 4.

FIG. 4 shows a filling machine 1a which differs from the filling machine 1 purely in that the ring transferring means 17a. corresponding to the ring transferring means 17 of the filling machine 1, is not provided directly on the underside of the ring-shaped rotor portion 4.1 but deeper within the region of the transition between the machine frame 3 and the rotor 4, i.e. in the region of the bearing 5, surrounding said bearing in a concentric manner. The ring transferring means 17a, which once again is arranged outside the rotor inner region surrounded by a rotor housing 27, or its ring transferring element 19 are then connected on the rotor side to the interior space 16 of the extension 15 by means of a plurality of channels 28, which are arranged on the outside with reference to the cone-shaped rotor housing 27 and are closed towards the surrounding area, or via an annular channel 28, which is closed towards the surrounding area and is formed between a wall element of the rotor housing 27 and an additional outer wall element.

FIG. 5 shows, as a further embodiment, a filling machine 1b that differs from the filling machine 1 purely in that the ring transferring means 17b, corresponding to the ring transferring means 17, is arranged below the rotary connection 12 and the lines 29 connecting the ring transferring means 17b to the interior space 16 of the extension 15 are located inside the chamber that is surrounded by the rotor housing 27.

One essential advantage of the design of the enclosure 13 described and of the supplying of the sterile gaseous and/or vaporous medium via the ring transferring means 17, 17a or 17b and the extension 15 into the interior space 14 of the enclosure 13 is that all the wall elements of the housing of the enclosure 13 and also of the extension 15 are provided exclusively on the rotor 4, there being no transition between the wall portions or elements that do rotate with the rotor and the wall portions or elements that do not rotate with the rotor either in the region of the enclosure 13 or in the region of the extension 15. This produces a simple housing structure for the enclosure 13 and the extension 15. Seals in the region of the interior spaces 14 and 16 are not necessary. The housing of the enclosure 13 and of the extension 15, the ring transferring means 17, 17a or 17b and the associated connections can be designed such that penetration of germs into the interior spaces 14 and 16 is excluded in practice, the enclosure 13 therefore forming an FDA-approved sterile lock.

In addition, losses of the sterile gaseous and/or vaporous medium at the transitions between rotating and non-rotating wall portions and the turbulence and/or transverse flows in the interior space 14, i.e. in the sterile or clean chamber, that this causes impairing the sterile filling process are avoided.

The ring transferring means 17, 17a, 17b are realized in each case with a large diameter. The advantage of this design is that it is possible to transfer the sterile gaseous and/or vaporous medium to the extension 15 over a large cross section of flow.

The ring transferring means 17, 17a or 17b can be realized in a relatively simple and nevertheless extremely operationally reliable structure.

By arranging the ring transferring means 17 or 17a on the outside, not only said ring transferring means but also all the elements that are connected thereto are easily accessible, among other things for repair and maintenance purposes, especially however for cleaning and sterilizing. By arranging the ring transferring means 17 or 17a and the lines connected thereto on the outside, it is also possible to provide sterile air filters on the filling machine 1 in an easily accessible manner.

Another advantage of the described design of the filling machine 1, 1a or 1b is that via the extension 15 or the distributor or interior space 16 at that location, a particularly even distribution of the supplied sterile gaseous and/or vaporous medium and consequently in particular also an even flow of said medium is achieved with no turbulence etc inside the enclosure 13. This is produced in that the flow of the sterile gaseous and/or vaporous medium, after entering the interior space 16, experiences a deflection about approximately 90° and then, with reference to the machine axis MA, is directed to the outside in a radial manner, with an increasing effective cross section of flow of the interior space 16.

The method of operation of the filling machines 1, 1a, 1b corresponds to the method of operation known by the expert, i.e. the bottles 2 to be filled are supplied at a container inlet to the filling positions 6 on the rotor 4. The filled bottles 2 are removed from the filling positions 6 at a container outlet.

The invention has been described above by way of exemplary embodiments. It is obvious that changes and conversion are possible without in any way departing from the inventive concept underlying the invention.

### LIST OF REFERENCES

1, 1a, 1b Filling machine
2 Bottle
2.1 Mouth flange
3 Machine frame
4 Rotor
4.1 Ring-shaped portion of the rotor 4
5 Bearing
6 Filling position
7 Fill element
8 Flow meter
9 Container or bottle carrier
10 Product line
11 Boiler
12 Rotary connection
13 Enclosure
14 Interior space of the enclosure 13
15 Extension
15.1 Wall portion
16 Interior space of the extension 15
17, 17a, 17b Ring transferring means
18 Line
19 Element of the ring transferring means 17
20 Leg
21 Yoke portion
22 Opening
23 Machine-frame-side element of the ring transferring means 17
24
25 Yoke portion
26 Annular channel
27 Rotor housing
28, 29 Channel
A, B Flow direction of the sterile gaseous and/or vaporous medium
M Machine axis

1. A machine of the rotating type for processing containers, said machine comprising:
a machine frame;
a rotor mounted on said machine frame so as to be rotatable about a vertical machine axis and rotatably driveable about said machine axis,
a plurality of processing positions at the rotor, each of which includes:
a ring-shaped enclosure that concentrically surrounds the machine axis, said enclosure or a housing thereof, forming an interior space that is defined towards a surrounding area and that can be impinged upon with a sterile gaseous and/or vaporous medium, said enclosure or wall portions forming said housing, being provided exclusively at said rotor, said interior space being connected by a ring-transferring means to a source of the sterile gaseous and/or vaporous medium that does not rotate with the rotor, and
one or more functional elements for processing the containers, said one or more functional elements extending into the interior space at least by way of a part region that interacts with the containers and in which the containers are accommodated by way of a mouth region during the processing.

2. The container processing machine of claim 1,
wherein the interior space of the enclosure communicates with an interior space of an extension that surrounds the machine axis in a ring-shaped manner,
said interior space being closed towards the surrounding area and serving as a distributor space, and
wherein the interior space of the extension is connected to the ring transferring means.

3. The container processing machine of claim 2, wherein the extension is radially offset from the machine axis relative to the interior space of the enclosure.

4. The container processing machine of claim 2, wherein the at least one ring transferring means is provided directly at the enclosure opposite the same but radially offset with reference to the machine axis.

5. The container processing machine of claim 4, wherein the ring transferring means is provided directly at the extension.

6. The container processing machine of claim 1, wherein the at least one ring transferring means is provided at a spacing below the enclosure.

7. The container processing machine of claim 1, wherein the at least one ring distributor is arranged outside a rotor interior space that is surrounded by a rotor housing.

8. The container processing machine of claim 1, wherein the at least one ring transferring means comprises
at least one rotor-side ring transferring element that rotates with the rotor and
one machine-frame-side ring transferring element that does not rotate with the rotor, and
wherein the rotor-side ring transferrin element and the machine-frame-side ring transferring element cooperate to form a rotary fluid connection, sealed towards the outside, for the gaseous and/or vaporous medium.

9. The container processing machine of claim 8, wherein the rotor-side ring transferring element and the machine-frame-side ring transferring element form a labyrinth seal.

10. The container processing machine of claim 1, wherein the one or more functional elements comprise a fill element.

11. The container processing machine of claim 1, wherein the one or more functional elements comprise a closing tool.

12. The container processing machine of claim 3, wherein the extension is radially offset inward relative to the machine axis.

13. The container processing machine of claim 5, wherein the ring transferring means is provided directly at the extension in an axial direction parallel to the machine axis below the extension.

14. The container processing machine of claim 2, wherein the at least one ring transferring means is provided at a spacing below the extension.

15. The container processing machine of claim 1, wherein the at least one ring transferring means is provided at a transition between the rotor and the machine frame.

16. The container processing machine of claim 1, wherein the at least one ring transferring means is provided below a rotary distributor for supplying operating media to the rotor.

17. The container processing machine of claim 8, wherein the rotor-side ring transferring element and the machine-frame-side ring transferring element form a surge tank seal.

18. The container processing machine of claim 8, wherein the rotor-side ring transferring element and the machine-frame-side ring transferring element form a siphon seal.
